(19) United States
(12) Patent Application Publication
(10) Pub. No.: US 2024/0295786 A1
(43) Pub. Date: Sep. 5, 2024

(54) DISPLAY PANEL AND DISPLAY APPARATUS

(71) Applicant: BOE Technology Group Co., Ltd., Beijing (CN)

(72) Inventors: Xianqin MENG, Beijing (CN); Weiting PENG, Beijing (CN); Wei WANG, Beijing (CN); Xiaochuan CHEN, Beijing (CN)

(21) Appl. No.: 17/800,004

(22) PCT Filed: Oct. 22, 2021
(86) PCT No.: PCT/CN2021/125549

§ 371 Date: Aug. 16, 2022

(30) Foreign Application Priority Data
Feb. 19, 2021 (CN) 202110191957.9

(51) Int. Cl. G02F 1/1368; G02F 1/1362

(52) U.S. Cl. CPC G02F 1/1368; G02F 1/136286

(57) ABSTRACT

The disclosure provides a display panel and a display apparatus. The display panel includes: an array substrate, an opposite substrate and a liquid crystal layer. The array substrate includes: a base substrate; a reflective layer on one side of the base substrate facing the opposite substrate, including a light transmission region and a reflective region; a buffer layer on one side of the reflective layer away from the base substrate; and a drive line layer on one side of the buffer layer away from the reflective layer, including a plurality of thin film transistors, wherein orthographic projections of channel regions of the thin film transistors on the base substrate are within an orthographic projection of the reflective region of the reflective layer on the base substrate.

### CROSS REFERENCE TO RELATED APPLICATIONS

This application is a National Stage of International Application No. PCT/CN2021/125549, filed on Oct. 22, 2021, which claims priority to Chinese Patent Application No. 202110191957.9, filed to China National Intellectual Property Administration on Feb. 19, 2021, the entire contents of which are incorporated herein by reference.

### FIELD

The disclosure relates to the field of display technology, in particular to a display panel and a display apparatus.

### BACKGROUND

With the continuous development of a display technology, light and thin display products with narrow frames are more and more popular. Currently, commonly used displays are liquid crystal displays (LCDs) and organic light-emitting diode (OLED) displays. The liquid crystal displays have the advantages of low cost, high resolution, long service life and the like, and still occupy a certain market share.

The LCD is a passive display panel that needs to cooperate with backlight for image display: The backlight realizes accurate change of a deflection angle of a liquid crystal through a drive circuit of the LCD to realize a bright and dark gray scale, and then the light of the bright and dark gray scale passes through a color film to realize the color display of an accurate gray scale.

Pixels in the LCD have a certain aperture ratio. Since the LCD can only modulate polarized light, the LCD needs to be set with a polarizer. In addition, the absorption of the backlight by a film layer in the LCD will also lose part of the backlight, resulting in only 5-6% of the light efficiency that can be effectively used. If the LCD display PPI increases, the pixel aperture ratio will further decrease. Therefore, how to improve the light efficiency and reduce the power consumption is the current urgent problem to be solved.

### SUMMARY

In a first aspect, an embodiment of the disclosure provides a display panel, including: an array substrate: an opposite substrate opposite to the array substrate; and a liquid crystal layer between the array substrate and the opposite substrate: wherein the array substrate includes: a base substrate; a reflective layer on one side of the base substrate facing the opposite substrate, including a light transmission region and a reflective region; a buffer layer on one side of the reflective layer away from the base substrate; and a drive line layer on one side of the buffer layer away from the reflective layer: wherein the drive line layer includes a plurality of thin film transistors, and orthographic projections of channel regions of the thin film transistors on the base substrate are located within an orthographic projection of the reflective region of the reflective layer on the base substrate.

In some embodiments of the disclosure, the array substrate further includes: a reflective polarizing layer on one side of the base substrate away from the reflective layer; wherein the reflective polarizing layer is configured to transmit first linearly polarized light and reflect second linearly polarized light, and a polarizing direction of the first linearly polarized light and a polarizing direction of the second linearly polarized light are perpendicular to each other.

In some embodiments of the disclosure, a reflectivity of the reflective layer is greater than 80%.

In some embodiments of the disclosure, a material of the reflective layer is aluminum, argentum or an aluminum alloy.

In some embodiments of the disclosure, a thickness of the reflective layer is greater than or equal to 100 nm.

In some embodiments of the disclosure, the drive line layer includes: an active layer on one side of the buffer layer away from the reflective layer: a gate insulating layer on one side of the active layer away from the buffer layer: a gate metal layer on one side of the gate insulating layer away from the active layer, including gates and gate lines: an interlayer insulating layer on one side of the gate metal layer away from the gate insulating layer; and a source-drain metal layer on one side of the interlayer insulating layer away from the gate metal layer, including sources, drains and data lines: wherein each of the gates, the sources, and the drains, and the corresponding active layer constitute each of the thin film transistors; and the orthographic projection of the reflective region of the reflective layer on the base substrate is of a grid structure, and orthographic projections of the gate lines and the data lines on the base substrate are within the orthographic projection of the reflective region of the reflective layer on the base substrate.

In some embodiments of the disclosure, the reflective polarizing layer includes: a polarizing layer on one side of the base substrate away from the reflective layer; and a plurality of first dielectric layers and a plurality of second dielectric layers on one side of the polarizing layer away from the base substrate, wherein the first dielectric layers and the second dielectric layers are alternately disposed in a stacked mode, and the first dielectric layers and the second dielectric layers are different in refraction index.

In some embodiments of the disclosure, the reflective polarizing layer includes: a plurality of metal lines on one side of the base substrate away from the reflective layer, wherein the plurality of metal lines are disposed in parallel and at equal intervals.

In a second aspect, an embodiment of the disclosure provides a display apparatus, including any of the above display panels and a backlight module located on a light incident side of the display panel.

In some embodiments of the disclosure, the backlight module includes: a substrate: a plurality of mini light emitting diodes on the substrate: a reflective layer on one side of the substrate facing the mini light emitting diodes, including openings configured to expose the mini light emitting diodes: an encapsulation layer on one sides of the mini light emitting diodes away from the substrate, configured to encapsulate and protect the mini light emitting diodes; and a prism sheet on one side of the encapsulation layer away from the substrate.

In some embodiments of the disclosure, the mini light emitting diodes are blue-light mini light emitting diodes; and the backlight module further includes: a quantum dot layer between the encapsulation layer and the prism sheet.

In some embodiments of the disclosure, the backlight module includes: a substrate: a light guide plate on the substrate, including a light incident surface and a light emitting surface; a plurality of mini light emitting diodes on one side of the light incident surface of the light guide plate: a reflective layer between the light guide plate and the substrate; and a prism sheet on one side of the light emitting surface of the light guide plate.

In some embodiments of the disclosure, the mini light emitting diodes are blue-light mini light emitting diodes; and the backlight module further includes: a quantum dot layer between the light guide plate and the prism sheet.

In some embodiments of the disclosure, a material of the reflective layer is white ink, and the white ink is doped with scattering particles.

### BRIEF DESCRIPTION OF THE DRAWINGS

In order to explain technical solutions of embodiments of the disclosure more clearly, the accompanying drawings that need to be used in the embodiments of the disclosure will be briefly introduced below. Apparently, the accompanying drawings introduced below are only some embodiments of the disclosure, and for those of ordinary skill in the art, on the premise of no creative labor, other accompanying drawings can also be obtained according to these accompanying drawings.

FIG. 1 is a schematic structural diagram of a conventional liquid crystal display apparatus.

FIG. 2 is a schematic sectional view of a display panel provided by an embodiment of the disclosure.

FIG. 3 is a comparison diagram of refraction index curves of different metals provided by an embodiment of the disclosure.

FIG. 4 is a comparison diagram of transmissivity curves of different metals provided by an embodiment of the disclosure.

FIG. 5 is a schematic sectional view of an array substrate provided by an embodiment of the disclosure.

FIG. 6 is a schematic top view of a display panel provided by an embodiment of the disclosure.

FIG. 7 is a principle diagram of a light path provided by an embodiment of the disclosure.

FIG. 8 is a first schematic sectional view of a reflective polarizing layer provided by an embodiment of the disclosure.

FIG. 9 is a second schematic sectional view of a reflective polarizing layer provided by an embodiment of the disclosure.

FIG. 10 is a schematic sectional view of a display apparatus provided by an embodiment of the disclosure.

FIG. 11 is a first schematic sectional view of a direct-type backlight module provided by an embodiment of the disclosure.

FIG. 12 is a second schematic sectional view of a direct-type backlight module provided by an embodiment of the disclosure.

FIG. 13 is a schematic sectional view of a conventional backlight module.

FIG. 14 is a comparison diagram of a viewing angle range after light in a conventional backlight module passes through each film.

FIG. 15 is a simplified schematic sectional view of a display apparatus for rapid verification provided by an embodiment of the disclosure.

FIG. 16 is a comparison diagram of optical gains provided by an embodiment of the disclosure.

FIG. 17 is a schematic sectional view of a side-entry backlight module provided by an embodiment of the disclosure.

### DETAILED DESCRIPTION OF THE EMBODIMENTS

In order to make above objectives, features and advantages of the disclosure more obvious and understandable, the disclosure will be further described below in combination with the accompanying drawings and embodiments. However, example implementations can be implemented in a variety of forms and should not be construed as limited to the implementations set forth herein; and on the contrary, providing these implementations makes the disclosure more comprehensive and complete, and comprehensively communicates the concept of the example implementations to those skilled in the art. In the figures, the same reference numerals represent the same or similar structures, so their repeated description will be omitted. The words expressing positions and directions described in the present application are illustrated by taking the accompanying drawings as an example, but they can also be changed as needed, and all the changes are included in the protection scope of the disclosure. The accompanying drawings of the disclosure are only used to illustrate a relative positional relationship and do not represent the true scale.

As the mainstream display screen at present, a liquid crystal display screen has the advantages of low power consumption, small size, low radiation and the like. A liquid crystal display panel is a non-self-luminous panel, and needs to be used in cooperation with a backlight module.

The liquid crystal display screen is mainly composed of a backlight module and a liquid crystal display panel. The liquid crystal display panel does not emit light itself, and needs to use a light source provided by the backlight module to realize brightness display.

The imaging principle of a liquid crystal display is that liquid crystals are placed between two pieces of conductive glass, an electric field effect that liquid crystal molecules are distorted is caused by driving of an electric field between two electrodes, so as to control transmission or shielding functions of a backlight source, thereby displaying images. If color light filters are added, color images may be displayed.

A display panel provided by an embodiment of the disclosure is a liquid crystal display panel, which may be used in a passive display mode, and may be applied to high PPI display, for example, virtual reality (VR), augmented reality (AR), mixed reality (MR) and other thin near-eye display, light field display and vehicle-mounted display and other fields.

FIG. 1 is a schematic structural diagram of a conventional liquid crystal display apparatus.

As shown in FIG. 1, the liquid crystal display apparatus usually includes: a liquid crystal display panel 100 and a backlight module 200 located on a light incident side of the liquid crystal display panel 100. The liquid crystal display panel 100 includes: an array substrate 11, an opposite substrate 12 and a liquid crystal layer 13.

Taking a liquid crystal display apparatus with 1200 pixels per inch (PPI) as an example, an aperture ratio of the array substrate 11 made of a low temperature polycrystalline oxide (LTPO) is 25-30%. At the same time, a liquid crystal only responds to the polarized light, so a lower polarizer p1 is between the backlight module 200 and the liquid crystal display panel 100, so as to realize single polarization transmission. A transmissivity of the lower polarizer p1 is generally 44%, then passes through the array substrate 11 with an aperture ratio of about 30%, then passes through the liquid crystal layer 13 with a transmissivity of about 90%, and then passes through a color film with a transmissivity of 30% and an upper polarizer p2 with a transmissivity of about 88%, and thus the light efficiency that can be effectively used is only 44%×30%×90%×30%×88%=3.1%. If the PPI of the display apparatus further increases, the aperture ratio of the array substrate 11 will also further decrease.

In order to meet the needs of near-eye display, such as VR and MR, a resolution of a display device is required to be greater than 1500 PPI, and meanwhile a brightness is required to be at least greater than 500 nit. If a structure of the liquid crystal display apparatus shown in FIG. 1 is adopted, the aperture ratio of the array substrate 11 is lower than 30% when the resolution is increased. If the superposition of the transmissivity of each functional layer in the display apparatus is considered, the actual light efficiency is only 1.2%. Coupled with light loss of each functional film layer in the backlight module, the light efficiency that can be effectively used for display is less than 1%, which contradicts the requirements of low power consumption and low heat generation required by the display device.

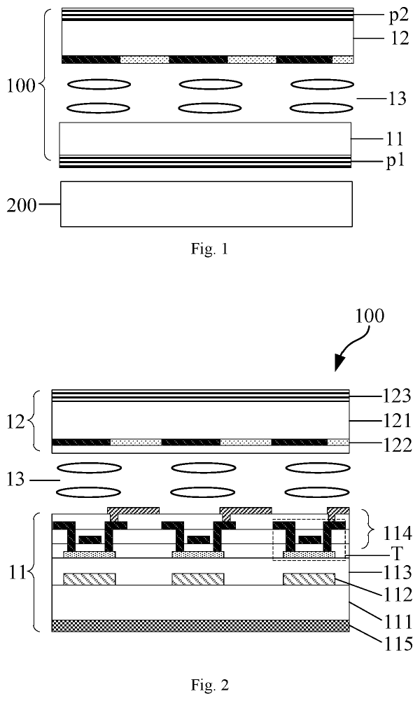

FIG. 2 is a schematic sectional view of a display panel provided by an embodiment of the disclosure.

As shown in FIG. 2, the display panel 100 provided by the embodiment of the disclosure includes: an array substrate 11 and an opposite substrate 12 opposite to each other, and a liquid crystal layer 13 between the array substrate 11 and the opposite substrate 12.

The array substrate 100 includes: a base substrate 111, a reflective layer 112, a buffer layer 113 and a drive line layer 114.

The base substrate 111, which usually is a glass substrate, is provided with functions of supporting and carrying.

The drive line layer 114 is disposed on one side of the base substrate 111 facing the opposite substrate 12. The drive line layer 114 includes a plurality of thin film transistors T, an active layer of each thin film transistor is provided with a channel region, and if the channel region is illuminated, the electric leakage of the thin film transistors T will be increased.

In order to avoid the above problem, according to the embodiment of the disclosure, the reflective layer 112 is disposed between the base substrate 111 and the drive line layer 114, the buffer layer 113 is formed on the reflective layer 112, and then the drive line layer 114 is formed on the buffer layer 113.

The buffer layer 113 plays a role of isolation and insulation between the reflective layer 112 and the drive line layer 114. The reflective layer 112 includes a light transmission region and a reflective region; and an orthographic projection of the reflective region on the base substrate completely covers orthographic projections of the channel regions of the thin film transistors T on the base substrate. In this way, the reflective layer 112 can play a role of shielding the channel regions of the thin film transistors T, and prevent the thin film transistors from causing electric leakage.

In order to improve the light efficiency, in the embodiment of the disclosure, the reflective layer 112 is not only provided with the function of shielding the channel regions, but also has a high reflectivity. So that light emitted from a backlight module can be transmitted from the light transmission region of the reflective layer 112. Light incident on the reflective region is efficiently reflected back into backlight, and this part of light will not be lost, and will be reflected again and incident into the display panel by a reflective film layer in the backlight module. So after multiple reflections and recycling, the light efficiency can be effectively improved.

In the display panel provided by the embodiment of the disclosure, the reflectivity of the reflective layer 112 may be as high as 80% or more, so that light incident on the reflective layer 112 may be returned to the backlight module as much as possible to be reused.

According to the above reflectivity requirements, the reflective layer 112 may be made of metal aluminum, argentum and other materials. The materials adopted by the reflective layer 112 are not limited in the embodiment of the disclosure. In addition to the above metals, the reflective layer may also adopt other alloy materials with a high reflectivity. For example, alloy aluminum and other materials may also be adopted. Since there are processes, such as annealing in a manufacturing process of the display panel, argentum is prone to being oxidized, and the reflectivity after oxidation decreases, so the alloy materials such as alloy aluminum may be adopted. The higher the reflectivity of the reflective layer, the better. A wet etching process may be adopted for manufacturing, and a good temperature resistance (below 300° C., the reflectivity is not affected) is realized, so that it is suitable for the process flow of the display panel for manufacturing.

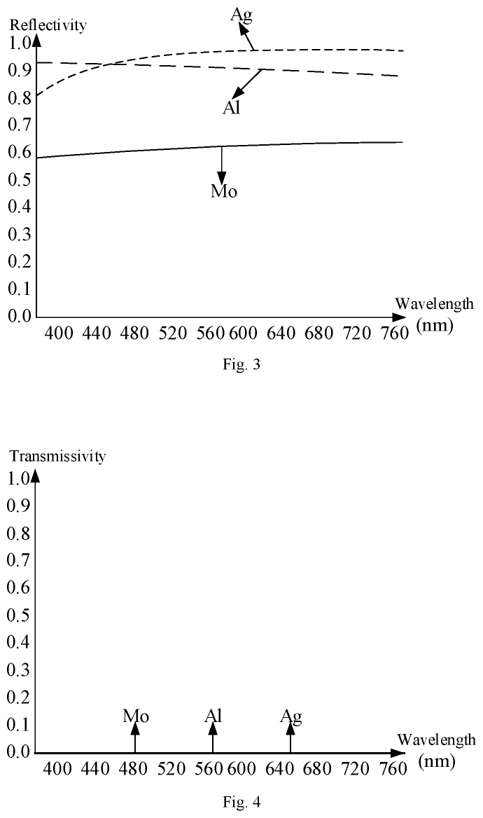

The embodiments of the disclosure perform optical simulation on reflective layers made of different metal materials. Specifically, molybdenum (Mo) of 100 nm, aluminum (Al) of 100 nm and argentum (Ag) of 100 nm are deposited on substrates, respectively, the reflectivity of the three metal layers is optically simulated, and a comparison diagram of reflectivity curves shown in FIG. 3 is obtained.

As shown in FIG. 3, Ag has a highest reflectivity in a white light range, followed by Al. and finally Mo. The reflectivity of Ag and Al is as high as 80% or more, and the reflectivity of Mo is about 55%. Therefore, for the reflection effect of light, the reflective layer made of Ag or Al may reflect more light back into the backlight module for recycling.

Of course, the metal material adopted by the reflective layer not only has a good reflection performance, but also needs a good light-shielding property, so that light can be prevented from being incident into the channel regions of the thin film transistors. FIG. 4 is a comparison diagram of transmissivity curves of the above three metals.

As shown in FIG. 4, the transmissivity of Mo, Al and Ag is zero. That is, all the three metals can meet the requirements of light shielding, which can prevent the light from being incident into the channel regions of the thin film transistors.

If the reflective layer 112 adopts Mo with the low reflectivity, more than 90% of white light incident on the reflective layer is absorbed and lost by Mo on average, and only 10% of the light is reflected back into the backlight module for reuse.

If the reflective layer 112 adopts Ag or Al, more than 90% of light incident on the reflective layer may be reflected back into the backlight module for reuse, which can improve the light efficiency utilization of backlight.

If the loss of transmissivity of each film material in the backlight module is not considered, when a material such as black matrix is adopted to form the same pattern as the reflective layer 112, the light efficiency at this time is 100% (the backlight)×44% (the transmissivity of the lower polarizer)×30% (the aperture ratio of the array substrate)=13.2%.

If Mo is adopted to manufacture the reflective layer, the light efficiency is 100% (the backlight)×44% (the transmissivity of the lower polarizer)×30% (the aperture ratio of the array substrate)+100% (the backlight)×44% (the transmissivity of the lower polarizer)×30% (the aperture ratio of the array substrate)×10% (reflectivity contribution of Mo)=14.52%. If Ag is adopted to manufacture the reflective layer, the light efficiency is 100% (the backlight)×44% (the transmissivity of the lower polarizer)×30% (the aperture ratio of the array substrate)+100% (the backlight)×44% (the transmissivity of the lower polarizer)×30% (the aperture ratio of the array substrate)×90% (reflectivity contribution of Ag)=25.08%.

A theoretical light efficiency gain of Ag compared with Mo is (25.08%-14.52%)/14.52%=98.3%.

It can be seen that the reflective layer 112 has a higher light efficiency gain when adopting metal Ag or Al. However, the actual light efficiency gain may further be affected by many factors, such as the loss of reflected light passing through each film layer in the backlight module, the absorption loss of the reflective layer, and the quantity of times of oscillations of light between a reflective film layer and the reflective layer 112 of the backlight module and be reduced.

In a specific implementation, the reflective layer 112 may be made of materials such as Ag. Al or an Al alloy, and the thickness may be set to be more than 100 nm, so as to have a high reflective performance.

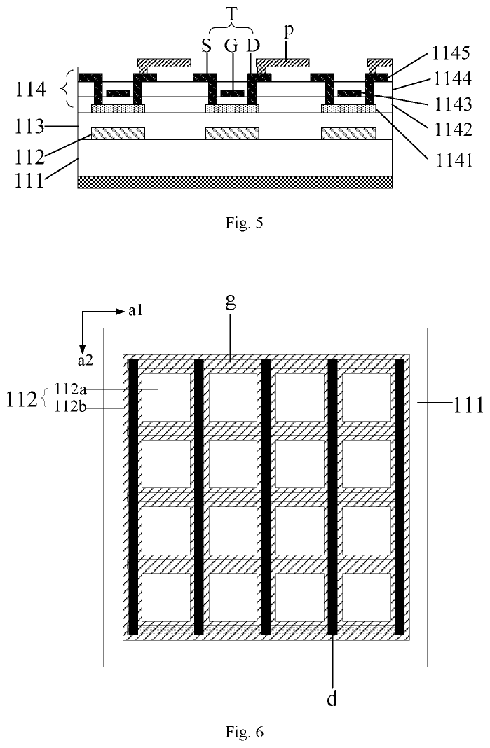

FIG. 5 is a schematic sectional view of an array substrate provided by an embodiment of the disclosure.

As shown in FIG. 5, the drive line layer includes: an active layer 1141, a gate insulating layer 1142, a gate metal layer 1143, an interlayer insulating layer 1144, a source-drain metal layer 1145 and other film layers.

The active layer 1141 is located on one side of the buffer layer 113 away from the reflective layer 112. The active layer 1141 is a functional film layer for making thin film transistors, and the active layer 1141 has a preset pattern. The active layer 1141 includes a source region and a drain region formed by doping N-type ions or P-type ions, and a region between the source region and the drain region is a channel region that is not doped.

The gate insulating layer 1142 is located on one side of the active layer 1141 away from the buffer layer 113. The gate insulating layer 1142 is configured to insulate a metal layer above the active layer 1141. A material of the gate insulating layer 1142 may be silicon oxide, silicon nitride and the like, which is not limited here.

The gate metal layer 1143 is located on one side of the gate insulating layer 1142 away from the active layer 1141. The gate metal layer 1143 has a pattern including gates G and gate lines. The gate metal layer 1143 may be a single layer or be of a multi-layer metal laminated structure, which is not limited here.

The interlayer insulating layer 1144 is located on one side of the gate metal layer 1143 away from the gate insulating layer 1142. The interlayer insulating layer 1144 is configured to insulate a metal layer above the gate metal layer 1143. A material of the interlayer insulating layer 1144 may be silicon oxide, silicon nitride and the like, which is not limited here.

The source-drain metal layer 1145 is located on one side of the interlayer insulating layer 1144 away from the gate metal layer 1143. The source-drain metal layer 1145 has a pattern including sources S, drains D and data lines. The source-drain metal layer 1145 may be a single-layer or be of a multi-layer metal laminated structure, which is not limited here.

A gate G, a source S, a drain D and the corresponding active layer 1141 constitute a thin film transistor T.

A flat layer is located on one side of the source-drain metal layer 1145 away from the interlayer insulating layer 1144. The flat layer is configured to insulate the source-drain metal layer 1145 and flatten a film layer surface at the same time, which is conducive to formation of other structures on the flat layer. The flat layer may be made of resin and other materials, which is not limited here. A surface of the flat layer has via holes exposing the drains, and a pattern of a pixel electrode may further be formed on the flat layer.

FIG. 6 is a schematic top view of a display panel provided by an embodiment of the disclosure.

As shown in FIG. 6, the gate lines g extend in a first direction a1 and are arranged in a second direction a2; and the data lines d extend in the second direction a2 and are arranged in the first direction a1. The first direction a1 may be a direction of a pixel unit row; the second direction a2 may be a direction of a pixel unit column, and the first direction a1 and the second direction a2 are perpendicular to each other.

The gate lines g and the data lines d form an intersecting grid structure. In the embodiment of the disclosure, the light transmission region 112a of the reflective layer 112 is a region exposing an opening where a pixel unit is located, and is provided with no pattern of the reflective layer. The reflective region 112b of the reflective layer 112 is a region where the pattern of the reflective layer is located, the pattern of the reflective region 112b of the reflective layer 112 is set to be of a grid structure, so that orthographic projections of the gate lines g and the data lines d on the base substrate 111 are both located within an orthographic projection of the reflective region 112b on the base substrate 111, which can effectively shield the channel regions of the thin film transistors. At the same time, since the gate lines g and the data lines d are not transparent originally and the light emitted from the backlight module incident on the positions of the gate lines g and the data lines d is lost, the reflective layer 112 is also disposed in a region corresponding to the patterns of the gate lines g and the data lines d, and the light that may be incident on the region is efficiently reflected back into the backlight module for reuse, which is conducive to improving the light efficiency.

As shown in FIG. 2, the array substrate 11 further includes: a reflective polarizing layer 115 on one side of the base substrate 111 away from the reflective layer 112. The reflective polarizing layer 115 is configured to transmit first linearly polarized light and reflect second linearly polarized light, and a polarizing direction of the first linearly polarized light and a polarizing direction of the second linearly polarized light are perpendicular to each other.

Generally, the lower polarizer on one side of the liquid crystal display panel close to the backlight module is an absorption polarizer, that is, the linearly polarized light in a specific polarization direction is transmitted, and the light with a polarization direction perpendicular to it is absorbed. In order to improve the light efficiency, according to the embodiment of the disclosure, the reflective polarizing layer 115 is disposed on the side of the display panel 100 close to the backlight module 200, and the reflective polarizing layer 115 can transmit the first linearly polarized light and reflect the second linearly polarized light perpendicular to the polarization direction of the first linearly polarized light. In this way, the second linearly polarized light reflected back into the backlight module 200 may be decomposed into first linearly polarized light and second linearly polarized light again after being reflected by a reflective film layer, then the first linearly polarized light decomposed again may pass through the reflective polarizing layer 115, and the second linearly polarized light decomposed again is reflected again. After the above circular reflection, the light efficiency can be effectively improved.

Further, when the light transmitted by the reflective polarizing layer 115 is incident on the reflective region of the reflective layer 112, the light may further be reflected back into the backlight module 200 for reuse. Therefore, combined with the synergistic effect of the reflective layer 112 and the reflective polarizing layer 115, the light efficiency can be effectively improved, and a purpose of reducing the backlight power consumption is realized.

The above first linearly polarized light may be linearly polarized light with the polarization direction parallel to the light incident surface, namely light P. The second linearly polarized light may be linearly polarized light with the polarization direction perpendicular to the light incident surface, namely light S.

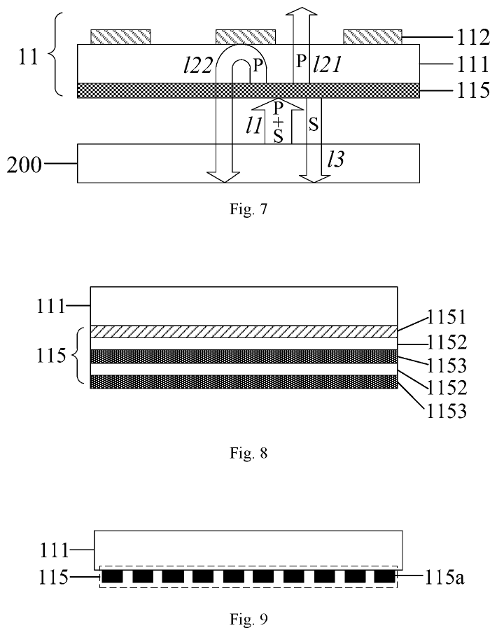

FIG. 7 is a principle diagram of a light path provided by an embodiment of the disclosure.

As shown in FIG. 7, the light l1 emitted from the backlight module 200 may usually be decomposed into light P and light S, when the light l1 emitted from the backlight module 200 is incident on the reflective polarizing layer 115, the light P is transmitted, the light S 13 is reflected, and the light S l3 reflected back into the backlight module 200 may be reflected by a reflective film layer in the backlight module to be reused. In the light P transmitted by the reflective polarizing layer 115, part of light l21 is incident on the light transmission region (namely a pixel opening region) of the reflective layer 112, this part of light 121 is directly transmitted, the other part of light l22 is incident on the reflective region of the reflective layer 112, and this part of light l22 may be reflected back into the backlight module by the reflective layer 112, so as to be reflected by the reflective film layer in the backlight module to be reused. Therefore, the light efficiency of the display apparatus can be significantly improved.

The reflective polarizing layer 115 is configured to transmit the light P and reflect the light S. The reflective polarizing layer 115 for realizing the purpose may adopt a multilayer advance polarizer film (APF) or a waveguide pol (WGP).

FIG. 8 is a first schematic sectional view of a reflective polarizing layer provided by an embodiment of the disclosure.

As shown in FIG. 8, when the reflective polarizing layer 115 adopts APF pol, the reflective polarizing layer 115 includes: a polarizing layer 1151, located on one side of the base substrate 111 away from the reflective layer; and a plurality of first dielectric layers 1152 and a plurality of second dielectric layers 1153, located on one side of the polarizing layer 1151 away from the base substrate 111, wherein the first dielectric layers 1152 and the second dielectric layers 1153 are alternately disposed in a stacked mode, and the first dielectric layers 1152 and the second dielectric layers 1153 are different in refraction index.

The high and low refraction indexes of the first dielectric layers 1152 and the second dielectric layers 1153 overlap each other, the thicknesses of the first dielectric layers 1152 and the second dielectric layers 1153 are accurately controlled through an extrusion and stretching process, so that a high reflectivity can be realized. By attaching the stacked multiple layers to the traditional polarizing layer 1151, the effects of transmitting the light P and reflecting the light S can be realized.

At present, the transmissivity of the adopted APF pol is 42%, and the reflectivity may reach 50%. In the display panel provided by the embodiment of the disclosure, APF pol reflects 50% of single polarized light back to backlight, if the aperture ratio of the array substrate 11 is 30%, the light of 50% (reflected by the reflective polarizing layer 115)+50% (transmitted by the reflective polarizing layer 115)×70% (reflected by the reflective layer 112)×90% (the reflectivity of the reflective layer 112) emitted from the backlight module may be reflected back to the backlight module, and then after being reflected by the reflective film layer in the backlight module, the light is emitted to the display panel 100 again. The oscillation between the reflective layer 112 and the backlight module is repeated to effectively improve the light efficiency.

FIG. 9 is a second schematic sectional view of a reflective polarizing layer provided by an embodiment of the disclosure.

As shown in FIG. 9, when the reflective polarizing layer 115 adopts WGP, the reflective polarizing layer 115 includes: a plurality of metal lines 115a on one side of the base substrate 111 away from the reflective layer, wherein the plurality of metal lines 115a are disposed in parallel and at equal intervals.

Specifically, a metal layer thin film may be plated on the base substrate 111, then an etching process is adopted to form a metal wire gating structure, and then the metal wire gating structure is flattened. The use of WGP (a metal wire gating polarizer) does not need to additionally attach a polarizing layer, and the whole process may be compatible with the display panel process.

After WGP is formed, the linearly polarized light with the polarization direction parallel to the metal lines 115a may be transmitted, and the linearly polarized light with the polarization direction perpendicular to the metal lines 115a is reflected, so as to realize reflective polarization.

As shown in FIG. 2, the opposite substrate 12 in the embodiment of the disclosure may be a color film substrate, and the color film substrate may include a base 121, a color film layer 122 located on one side of the base 121 facing the array substrate 11, and an upper polarizer 123 located on one side of the base 121 away from the color film layer 122. The manufacturing process of the color film substrate may adopt a traditional process, and the upper polarizer 123 may adopt an absorption polarizer, which is not limited here.

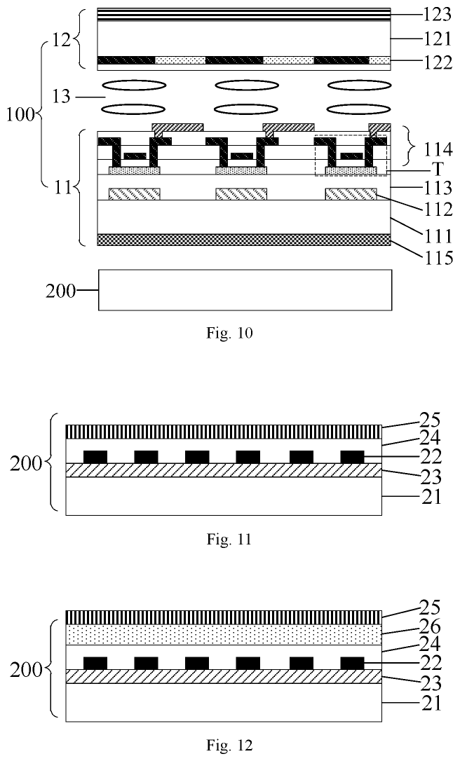

Based on the same inventive concept, an embodiment of the disclosure provides a display apparatus. FIG. 10 is a schematic sectional view of the display apparatus provided by the embodiment of the disclosure.

As shown in FIG. 10, the display apparatus provided by the embodiment of the disclosure includes: any of the above display panels 100 and the backlight module 200 located on a light incident side of the display panel 100.

In general, in order to realize a high uniformity and a high brightness under a visual angle of the backlight module, optical films such as a diffusion film and a prism film may be disposed in the backlight module. However, in the display apparatus provided by the embodiment of the disclosure, since the reflective layer 112 and the reflective polarizing layer 115 are disposed in the display panel, half of the light incident on the reflective polarizing layer 115 may be reflected back into the backlight module, and other light incident on the reflective layer 112 may also be reflected back into the backlight module again. The reflected light is depolarized through each film layer in the backlight module, and may be reused again and again. In the above process, the film layer structure in the backlight module may scatter the reused light, which may replace the role of a diffusion sheet. Therefore, the backlight module provided by the embodiment of the disclosure may omit an original diffusion sheet structure, reduce the overall thickness of the device, and reduce the absorption loss caused by the diffusion sheet at the same time.

FIG. 11 is a schematic sectional view of a direct-type backlight module provided by an embodiment of the disclosure.

As shown in FIG. 11, the backlight module 200 includes: a substrate 21, mini light emitting diodes 22, a reflective layer 23, an encapsulation layer 24 and a prism sheet 25.

The substrate 21 is located at the bottom of the backlight module and has effects of supporting and carrying. The substrate 21 may be a glass substrate, and may also be transparent polyimide (PI) or a flexible printed circuit (FPC), which is not limited here.

A plurality of mini light emitting diodes (Mini LEDs) 22 are located on the substrate 21. A drive circuit for driving the Mini LEDs 22 is formed on the substrate 21, and the Mini LEDs 22 are welded to the substrate 21.

The Mini LEDs 22 are different from ordinary light emitting diodes, and refer to mini light emitting diode chips. Since the Mini LEDs 22 have small sizes, the backlight module can be controlled to dynamically emit light in smaller partitions, which can realize more refined dynamic control and improve dynamic contrast of the display apparatus.

The Mini LED may adopt a red-light Mini LED, a green-light Mini LED and a blue-light Mini LED, to realize white light by superposition: or may adopt the blue-light Mini LED, to be matched with a color conversion layer to mix into the white light, which is not limited here.

The reflective layer 23 is located on one side of the substrate 21 facing the Mini LEDs 22, and including openings configured to expose the Mini LEDs 22. The reflective layer 23 is an insulating protective layer, and has an effect of protecting an electronic circuit. The reflective layer 23 is formed in the way that a material with a light reflecting property is coated on the surface of the substrate 21 and then the positions of bonding pads for welding the Mini LEDs 22 are exposed through processes such as etching.

The reflective layer 23 is configured to reflect the light reflected back to the backlight module 200 again, so as to improve the utilization efficiency of light. In the embodiment of the disclosure, a material of the reflective layer 23 may adopt white ink, and the reflectivity of the reflective layer 23 is greater than 80% by controlling its thickness.

The encapsulation layer 24 is located on one sides of the Mini LEDs 22 away from the substrate 21, and configured to encapsulate and protect the Mini LEDs 22. The encapsulation layer 24 is a protective adhesive covering the surfaces of the Mini LEDs 22. The encapsulation layer 24 is configured to encapsulate and protect the Mini LEDs 22 and prevent foreign matter from entering the Mini LEDs 22. The encapsulation layer 24 may be made of a transparent gum material, such as silica gel, modified silica gel or epoxy resin with good permeability.

The prism sheet 25 is located on one side of the encapsulation layer 24 away from the substrate 21. The prism sheet 25 is configured to condense light from a large angle to a small angle, so as to improve the brightness of a central viewing angle. The prism sheet in the embodiment of the disclosure may adopt two prism films orthogonal to each other: or, orthogonal strip prisms may also be formed on both sides of a substrate respectively, so that the two prism films are integrated into one.

In the embodiment of the disclosure, the Mini LED 22 may adopt the blue-light Mini LED with an emission wavelength ranging from 380 nm to 420 nm. As shown in FIG. 12, a quantum dot layer 26 may be disposed between the encapsulation layer 24 and the prism sheet 25.

Red quantum dots and green quantum dots are dispersed in the quantum dot layer 26, the red quantum dots emit red light after being excited by blue light, and the green quantum dots emit green light after being excited by the blue light, so that the red light and green light emitted by exciting and the blue light emitted from the blue-light Mini LED are finally synthesized into white light.

The quantum dot layer 26 may further be replaced with a fluorescent color conversion film or other color conversion films, which is not limited here.

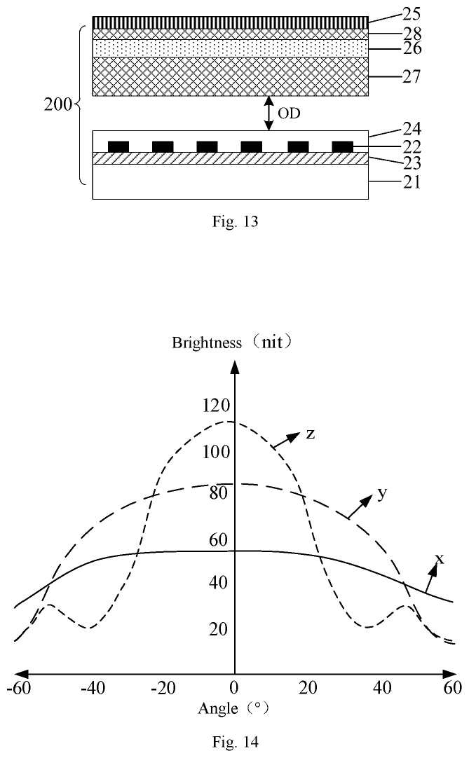

FIG. 13 is a schematic sectional view of a conventional backlight module.

As shown in FIG. 13, compared with the backlight module provided by the embodiment of the disclosure, the conventional backlight module may be further provided with a diffusion plate 27 and an upper diffusion sheet 28, and a certain light mixing distance OD is required between the Mini LED and the diffusion plate 27. In the conventional Mini LED backlight, the diffusion plate 27, the upper diffusion sheet 28 and the light mixing distance OD are generally adopted to realize light mixing, so that a spacing between two adjacent Mini LEDs is relatively large, thereby reducing the quantity of use of the Mini LEDs.

FIG. 14 is a comparison diagram of a viewing angle range after light in a conventional backlight module passes through each film.

As shown in FIG. 14, when the light passes through the light mixing distance OD, the diffusion plate 27, the quantum dot layer 26 and the upper diffusion sheet 28, an energy distribution curve corresponds to a curve x in FIG. 14. As shown in FIG. 14, the light energy distribution at a front viewing angle (the viewing angle is 0°) and a big viewing angle is relatively balanced, so using the light mixing distance OD, the diffusion plate 27 and the upper diffusion sheet 28 may realize more than 90% of uniform light.

The prism sheet 25 in the conventional backlight module may adopt two prism films orthogonal to each other. When the light passes through one of the prism films, the energy distribution curve corresponds to a curve y in FIG. 14. As shown in FIG. 14, the light may be focused under the front viewing angle, and the light energy may be concentrated within a viewing angle range of ±40°. When the light passes through the other prism film, the energy distribution curve corresponds to a curve z in FIG. 14. As shown in FIG. 14, the light may be further focused under the front viewing angle, and the light energy may be concentrated within a viewing angle range of ±20°. In this way, the light with high uniformity is condensed into the viewing angle range, and the brightness of the front viewing angle is improved.

In the display apparatus provided by the embodiment of the disclosure, since the reflective polarizing layer 115 and the reflective layer 112 are disposed in the display panel, most of light may be re-reflected back into the backlight module, and the reflected light is depolarized through each film layer in the backlight module and may be reused again and again. After repeating the above oscillation process for many times, the light can be diffused. Therefore, in the backlight module provided by the embodiment of the disclosure, the same optical effect as the conventional backlight module can be realized without disposing the diffusion layer 27, the upper diffusion sheet 28 and the light mixing distance OD.

For the backlight module, reducing a quantity of the film layers may reduce the path of light loss. Therefore, the backlight module provided by the embodiment of the disclosure removes the diffusion plate 27, the upper diffusion sheet 28 and the light mixing distance OD, which will undoubtedly improve the light transmissivity and reduce the thickness of the backlight module at the same time. The following table shows the comparison of structural thickness parameters between the conventional backlight module and the backlight module provided by the embodiment of the disclosure.

| | Thickness (mm) of | Thickness (mm) of | |
|---|---|---|---|
| | conventional | backlight module | |
| Structure | backlight module | of the disclosure | Note |
| Substrate (21) | 0.5 | 0.5 | It may be thinned |
| | | | as needed |
| Reflective layer | 0.1 | 0.1 | High reflectivity |
| (23) | | | |
| Mini LED (22) | 0.1 | 0.1 | |
| Encapsulation | 0.3 | 0.3 | It may be thinned |
| layer (24) | | | to 0.25 mm |
| Optical distance | 2 T | None | Removable |
| (OD) | | | |
| Diffusion plate | 2 T | None | Removable |
| (27) | | | |
| Quantum dot | 0.3 | 0.3 | Removable |
| layer (26) | | | |
| Upper diffusion | 0.1 | None | Removable |
| sheet (28) | | | |
| Prism sheet (25) | 0.15 | 0.15 | It may be integrated |
| | | | or split into two |
| | | | pieces |
| Total thickness | 5.55 | 1.45 | |

According to the thickness analysis of each film layer in the above table, the thickness of the backlight module provided by the embodiment of the disclosure may be reduced to less than 1.5 T, and the overall thickness is greatly reduced compared with the conventional backlight module structure.

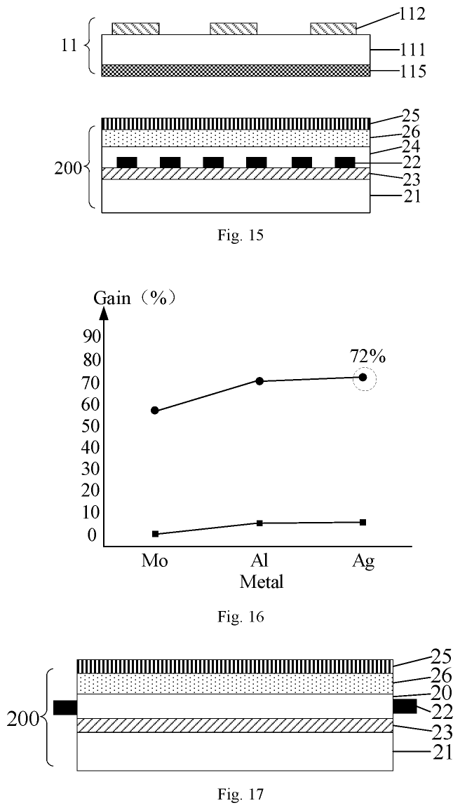

The embodiment of the disclosure further performs rapid verification on optical gains of the backlight module, since the display apparatus provided by the embodiment of the disclosure is mainly improved for the structure including the reflective layer 112 and its lower part in the array substrate 11, it only performs rapid verification for some structures shown in FIG. 15.

FIG. 16 is a comparison diagram of optical gains provided by an embodiment of the disclosure. A lower curve represents an optical gain value simulated by adopting the conventional backlight module structure, and an upper curve represents an optical gain value simulated by adopting the backlight module structure provided by the embodiment of the disclosure.

As shown in FIG. 16, when the conventional backlight module is adopted, Mo, Al and Ag each are adopted to manufacture the reflective layer 112, and the reflective polarizing layer 115 is disposed on the side of the display panel facing the backlight module, the simulated optical gain of the reflective layer 112 made of Al is 6%, and the simulated optical gain of the reflective layer 112 made of Ag is 8%.

When the backlight module provided by the embodiment of the disclosure is adopted, Mo, Al and Ag each are adopted to manufacture the reflective layer 112, and the reflective polarizing layer 115 is disposed on the side of the display panel facing the backlight module, the simulated optical gain of the reflective layer 112 made of Al is 10%, and the test gain is 12%. The theoretical value is basically similar to the actual measured value.

Based on the above correct simulation model, the backlight module is optimized. After the white ink of the reflective layer 23 is doped with scatting particles with high scattering properties, the scattering of light may be close to Lambertian scattering. Under this optimization condition, adopting Ag to manufacture the reflective layer 112 may realize a light efficiency improvement of up to 72%.

In the actual processing process, the reflective layer 23 is dripped with white oil and leveled, and the encapsulation layer on the surface of the Mini LED also has certain fluctuations. In the simulation, the white oil is regarded as specular reflection, and the encapsulation layer is also completely flat. Therefore, there is a certain error between the simulation value and the theoretical value, and the above optical simulation value can already verify that the backlight module provided by the embodiment of the disclosure can greatly improve the light efficiency.

The embodiment of the disclosure also models and analyzes two models of whether or not scattering particles are added in the reflective layer 23, and analyzes the uniformity of the conventional backlight module and the backlight module provided by the embodiment of the disclosure. See the table below for details.

| | | Backlight module | Backlight module |
|---|---|---|---|
| | Conventional | (without scattering | (with scatting |
| | backlight | particles) of the | particles) of the |
| | module | disclosure | disclosure |
| Backlight | 97% | 91.1% | 95.0% |
| uniformity | | | |

It can be seen from the above table that a scattering degree of the reflective layer 23 directly affects the uniformity of the backlight. Generally, the uniformity of the backlight is required to be above 90%, and the above three designs can realize the uniformity of above 90%. In order to meet the requirements of high-end display, the scattering particles or rough structures are added into the reflective layer 23, which can effectively increase the scattering degree to meet the requirements of Lambertian scattering.

The backlight module provided by the embodiment of the disclosure may adopt the direct-type backlight module, and may also adopt a side-entry backlight module. FIG. 17 is a schematic sectional view of the side-entry backlight module provided by the embodiment of the disclosure.

As shown in FIG. 17, the side-entry backlight module includes: a substrate 21, a light guide plate 20, mini light emitting diodes 22, a reflective layer 23 and a prism sheet 25.

The substrate 21 is located at the bottom of the backlight module and has effects of supporting and carrying. The substrate 21 may be a glass substrate, and may also be a metal back plate, which is not limited here.

The light guide plate 20 is located on the substrate 21 and configured to conduct light. The light guide plate 20 may be made of an acrylic plate or a polycarbonate (PC) plate, which is not limited here. The application principle of the light guide plate 20 is to use the total reflection property of light. When the light emitted from a light source is incident on the light guide plate at a set angle, the light guide plate has a high refraction index, so that the total reflection occurs when the light is incident on its surface, the light emitted from the light source may be transmitted from one side of the light guide plate to the other side, so as to convert a line light source into a surface light source, thereby providing backlight for the display panel.

Light guide points may be formed on a bottom surface of the light guide plate 20 by laser engraving. V-shaped cross grid engraving or UV screen printing technology. When the light is emitted to each light guide point, the reflected light may be diffused to all angles, and part of the light incident on an upper surface of the light guide plate no longer meets the condition of total reflection, so it may be emitted from the front of the light guide plate. By setting light guide points of different density and sizes, the light guide plate can emit light evenly.

The light guide plate 20 includes a light incident surface and a light emitting surface. As shown in FIG. 17, the light incident surface of the light guide plate 20 may be a side surface, and the light emitting surface is an upper surface.

A plurality of mini light emitting diodes 22 are located on one side of the light incident surface of the light guide plate 20. When the side-entry backlight module structure is adopted, usually the plurality of Mini light-emitting diodes 22 may be disposed as a light bar and on the side surface of the light guide plate 20. As shown in FIG. 17, in order to increase the overall brightness, light bars may also be disposed on the two opposite side surfaces of the light guide plate 20, which is not limited here.

The reflective layer 23 is located between the light guide plate 20 and the substrate 21. The reflective layer 23 is configured to reflect the light emitted from the lower surface of the light guide plate 20 back into the light guide plate, so that the light is finally emitted from the light emitting surface of the light guide plate, and the utilization efficiency of the light is improved.

In the embodiment of the disclosure, a material of the reflective layer 23 may adopt white ink, and the reflectivity of the reflective layer 23 is greater than 80% by controlling its thickness. In addition, the white ink may be doped with scattering particles, so that the reflective layer 23 has a better depolarization degree, and the scattering effect is closer to Lambertian scattering.

The prism sheet 25 is located on one side of the light emitting surface of the light guide plate 20. The prism sheet 25 is configured to condense light from a large angle to a small angle, so as to improve the brightness of a central viewing angle. The prism sheet in the embodiment of the disclosure may adopt two prism films orthogonal to each other: or, orthogonal strip prisms may also be formed on both sides of the substrate respectively, so that the two prism films are integrated into one.

In the embodiment of the disclosure, the Mini LED may adopt a red-light Mini LED, a green-light Mini LED and a blue-light Mini LED, to realize white light by superposition: or may adopt the blue-light Mini LED, to be matched with a color conversion layer to mix into the white light, which is not limited here.

When the Mini LED 22 may adopt the blue-light Mini LED, as shown in FIG. 12, a quantum dot layer 26 may be disposed between the light guide plate 20 and the prism sheet 25.

Red quantum dots and green quantum dots are dispersed in the quantum dot layer 26, the red quantum dots emit red light after being excited by blue light, and the green quantum dots emit green light after being excited by the blue light, so that the red light and green light emitted by exciting and the blue light emitted from the blue-light Mini LED are finally synthesized into white light.

The quantum dot layer 26 may further be replaced with a fluorescent color conversion film or other color conversion films, which is not limited here.

The side-entry backlight module is adopted by removing the diffusion plate and the upper diffusion sheet, and by matching the side-entry backlight module with the reflective layer 112 and the reflective polarizing layer 115 in the display panel, the backlight can be highly uniformed. The side-entry backlight module may further reduce the thickness of the backlight, and by matching the side-entry backlight module with the reflective polarizing layer 115 and the reflective layer 112 in the display panel, the light efficiency can be effectively improved.

Although the preferred embodiments of the disclosure have been described, those skilled in the art can make additional changes and modifications on these embodiments once they know the basic creative concept. Therefore, the appended claims are intended to be construed to include the preferred embodiments and all changes and modifications that fall into the scope of the disclosure.

Apparently, those skilled in the art can make various modifications and variations to the embodiments of the disclosure without departing from the spirit and scope of the embodiments of the disclosure. In this way, under the condition that these modifications and variations to the embodiments of the disclosure fall within the scope of the claims of the disclosure and their equivalent technologies, the disclosure is also intended to include these modifications and variations.

1. A display panel, comprising:
an array substrate;
an opposite substrate opposite to the array substrate; and
a liquid crystal layer between the array substrate and the opposite substrate;
wherein the array substrate comprises:
a base substrate;
a reflective layer on one side of the base substrate facing the opposite substrate, comprising a light transmission region and a reflective region;
a buffer layer on one side of the reflective layer away from the base substrate; and
a drive line layer on one side of the buffer layer away from the reflective layer; wherein
the drive line layer comprises a plurality of thin film transistors, and orthographic projections of channel regions of the thin film transistors on the base substrate are located within an orthographic projection of the reflective region of the reflective layer on the base substrate.

2. The display panel according to claim 1, wherein the array substrate further comprises:
a reflective polarizing layer on one side of the base substrate away from the reflective layer; wherein the reflective polarizing layer is configured to transmit first linearly polarized light and reflect second linearly polarized light, and a polarizing direction of the first linearly polarized light and a polarizing direction of the second linearly polarized light are perpendicular to each other.

3. The display panel according to claim 1, wherein a reflectivity of the reflective layer is greater than 80%.

4. The display panel according to claim 3, wherein a material of the reflective layer is aluminum, argentum or an aluminum alloy.

5. The display panel according to claim 4, wherein a thickness of the reflective layer is greater than or equal to 100 nm.

6. The display panel according to claim 1, wherein the drive line layer comprises:
an active layer on one side of the buffer layer away from the reflective layer;
a gate insulating layer on one side of the active layer away from the buffer layer;
a gate metal layer on one side of the gate insulating layer away from the active layer comprising gates and gate lines;
an interlayer insulating layer on one side of the gate metal layer away from the gate insulating layer; and
a source-drain metal layer on one side of the interlayer insulating layer away from the gate metal layer comprising sources, drains and data lines; wherein
each of the gates, the sources, and the drains, and the corresponding active layer constitute each of the thin film transistors; and
the orthographic projection of the reflective region of the reflective layer on the base substrate is of a grid structure, and orthographic projections of the gate lines and the data lines on the base substrate are within the orthographic projection of the reflective region of the reflective layer on the base substrate.

7. The display panel according to claim 2, wherein the reflective polarizing layer comprises:
a polarizing layer on one side of the base substrate away from the reflective layer; and
a plurality of first dielectric layers and a plurality of second dielectric layers on one side of the polarizing layer away from the base substrate, wherein the first dielectric layers and the second dielectric layers are alternately disposed in a stacked mode, and the first dielectric layers and the second dielectric layers are different in refraction index.

8. The display panel according to claim 2, wherein the reflective polarizing layer comprises:
a plurality of metal lines on one side of the base substrate away from the reflective layer, wherein the plurality of metal lines are disposed in parallel and at equal intervals.

9. A display apparatus, comprising the display panel according to claim 1 and a backlight module located on a light incident side of the display panel.

10. The display apparatus according to claim 9, wherein the backlight module comprises:
a substrate;
a plurality of mini light emitting diodes on the substrate;
a reflective layer on one side of the substrate facing the mini light emitting diodes, comprising openings configured to expose the mini light emitting diodes;
an encapsulation layer on one sides of the mini light emitting diodes away from the substrate, configured to encapsulate and protect the mini light emitting diodes; and
a prism sheet on one side of the encapsulation layer away from the substrate.

11. The display apparatus according to claim 10, wherein the mini light emitting diodes are blue-light mini light emitting diodes; and the backlight module further comprises:
a quantum dot layer between the encapsulation layer and the prism sheet.

12. The display apparatus according to claim 9, wherein the backlight module comprises:
a substrate;
a light guide plate on the substrate, comprising a light incident surface and a light emitting surface;
a plurality of mini light emitting diodes on one side of the light incident surface of the light guide plate;
a reflective layer between the light guide plate and the substrate; and
a prism sheet on one side of the light emitting surface of the light guide plate.

13. The display apparatus according to claim 12, wherein the mini light emitting diodes are blue-light mini light emitting diodes; and the backlight module further comprises:
a quantum dot layer between the light guide plate and the prism sheet.

14. The display apparatus according to claim 10, wherein a material of the reflective layer is white ink, and the white ink is doped with scattering particles.

15. The display panel according to claim 2, wherein a reflectivity of the reflective layer is greater than 80%.

16. The display panel according to claim 15, wherein a material of the reflective layer is aluminum, argentum or an aluminum alloy.

17. The display panel according to claim 2, wherein the drive line layer comprises:
an active layer on one side of the buffer layer away from the reflective layer;
a gate insulating layer on one side of the active layer away from the buffer layer;
a gate metal layer on one side of the gate insulating layer away from the active layer comprising gates and gate lines;
an interlayer insulating layer on one side of the gate metal layer away from the gate insulating layer; and
a source-drain metal layer on one side of the interlayer insulating layer away from the gate metal layer comprising sources, drains and data lines; wherein
each of the gates, the sources, and the drains, and the corresponding active layer constitute each of the thin film transistors; and
the orthographic projection of the reflective region of the reflective layer on the base substrate is of a grid structure, and orthographic projections of the gate lines and the data lines on the base substrate are within the orthographic projection of the reflective region of the reflective layer on the base substrate.

18. The display apparatus according to claim 12, wherein a material of the reflective layer is white ink, and the white ink is doped with scattering particles.
